(19) United States
(12) Patent Application Publication
(10) Pub. No.: US 2024/0006981 A1
(43) Pub. Date: Jan. 4, 2024

(54) SERIES CAPACITOR STEP-DOWN CONVERTER AS WELL AS CONTROLLER CIRCUIT AND CONTROL METHOD THEREOF

(71) Applicant: ROHM Co., LTD., Kyoto (JP)

(72) Inventors: Kazuki Hashimoto, Kyoto (JP); Akihiro KAWANO, Kyoto (JP)

(21) Appl. No.: 18/342,920

(22) Filed: Jun. 28, 2023

(30) Foreign Application Priority Data
Jun. 30, 2022 (JP) 2022-106110

(51) Int. Cl. H02M 1/084; H02M 1/00; H02M 3/07; H02M 3/158

(52) U.S. Cl. CPC H02M 1/084; H02M 1/0009; H02M 1/0029; H02M 1/0043; H02M 1/0087; H02M 3/072; H02M 3/1586

(57) ABSTRACT

Disclosed herein is a controller circuit for a series capacitor step-down converter. The circuit includes an oscillator that generates a clock signal, a control logic circuit that generates a plurality of control signals for controlling a plurality of switching elements of the series capacitor step-down converter in synchronization with the clock signal, a plurality of drivers that drive the plurality of switching elements according to the plurality of control signals, and a frequency controller that controls a frequency of the clock signal on the basis of an output voltage of the series capacitor step-down converter.

This application claims priority benefit of Japanese Patent Application No. JP 2022-106110 filed in the Japan Patent Office on Jun. 30, 2022. Each of the above-referenced applications is hereby incorporated herein by reference in its entirety.

### BACKGROUND

The present disclosure relates to a series capacitor converter.

A direct current to direct current (DC/DC) converter with a step-down function is used to generate a voltage lower than an input voltage. As a DC/DC converter having a step-down function, a step-down (buck) type, a step-up/step-down type, a Cuk type, a Zeta type, a single-ended primary-inductor converter (SEPIC) type, and other types are known.

Depending on the application, an interleaved type or a series capacitor type, which are variations of the step-down converter, are adopted. In the interleaved type, buck converters are connected in parallel and their inputs and outputs are connected in common to each other. High efficiency operation is achieved by interleaved operation of a plurality of buck converters. The interleaved type has the same step-down ratio as that of a normal buck converter.

A series capacitor step-down converter can be regarded as a modification of a converter of the interleaved type with a phase number of 2 and has a configuration with an added series capacitor. The step-down converter of the series capacitor type can reduce the step-down ratio to half the ratio of the interleaved type, and thus is suitable for applications that require a small step-down ratio.

An example of the related art is disclosed in “Stefano Saggini, Shuai Jiang, Mario Ursino, Chenhao Nan, ‘A 99% Efficient Dual-Phase Resonant Switched-Capacitor-Buck Converter for 48 V Data Center Bus Conversions,’ 2019 IEEE Applied Power Electronics Conference and Exposition (APEC).”

### BRIEF DESCRIPTION OF THE DRAWINGS

FIG. 1 is a circuit diagram of a series capacitor step-down converter according to an embodiment;

FIG. 2 is an equivalent circuit diagram of the series capacitor step-down converter (main circuit) in a first state;

FIG. 3 is an equivalent circuit diagram of the series capacitor step-down converter (main circuit) in a second state;

FIG. 4 is a current waveform diagram of the series capacitor step-down converter;

FIG. 5 is a current waveform diagram of the series capacitor step-down converter;

FIG. 6 is a time chart illustrating operation of the series capacitor step-down converter in consideration of a dead time;

FIG. 7 is a diagram illustrating a relation between an output current and an output voltage of the series capacitor step-down converter;

FIG. 8 is a block diagram of a controller integrated circuit (IC) according to Example 1;

FIG. 9 is a block diagram illustrating a configuration example of a frequency controller and an oscillator;

FIG. 10 is a block diagram illustrating a configuration example of a frequency controller and an oscillator;

FIG. 11 is a block diagram of a controller IC according to Example 2;

FIG. 12 is a block diagram illustrating a configuration example of a frequency controller;

FIG. 13 is a diagram illustrating a relation between the output current and a frequency of a clock signal;

FIG. 14 is a diagram for illustrating current waveforms when a switching frequency is changed; and

FIG. 15 is a diagram illustrating an example of an electronic device that includes the series capacitor step-down converter.

### DETAILED DESCRIPTION

### Overview of Embodiments

An overview of some exemplary embodiments of the present disclosure is provided. This overview presents some concepts of one or more embodiments in a simplified form, as a preamble to the more detailed description that is presented later, for the purpose of a basic understanding of the embodiments, and does not limit the scope of the disclosure. This overview is not a comprehensive overview of all conceivable embodiments, and it is intended to neither specify key elements of all embodiments nor delineate the scope of some or all embodiments. For convenience, “an embodiment” may be used to refer to one embodiment (example or modification) or a plurality of embodiments (examples or modifications) disclosed in the present specification.

A controller circuit for a series capacitor step-down converter according to an embodiment includes an oscillator that generates a clock signal, a control logic circuit that generates a plurality of control signals for controlling a plurality of switching elements of the series capacitor step-down converter in synchronization with the clock signal, a plurality of drivers that drive the plurality of switching elements according to the plurality of control signals, and a frequency controller that controls a frequency of the clock signal on the basis of an output voltage of the series capacitor step-down converter.

If a series capacitor step-down converter is operated at a duty cycle of 50%, its step-down ratio will be ¼, but the output voltage will fluctuate according to an output current. Therefore, load regulation can be improved by monitoring the output voltage and changing the frequency of the clock signal according to the output voltage.

In an embodiment, the frequency controller may reduce the frequency of the clock signal when the output voltage is lower than a predetermined threshold voltage and, and may increase the frequency of the clock signal when the output voltage is higher than the threshold voltage.

In an embodiment, the frequency controller may reduce the frequency of the clock signal when the output voltage is lower than a lower limit of a predetermined voltage range, and may increase the frequency of the clock signal when the output voltage is higher than an upper limit of the predetermined voltage range.

A controller circuit for a series capacitor step-down converter according to an embodiment includes an oscillator that generates a clock signal, a control logic circuit that generates a plurality of control signals for controlling a plurality of switching elements of the series capacitor step-down converter in synchronization with the clock signal, a plurality of drivers that drive the plurality of switching elements according to the plurality of control signals, and a frequency controller that monitors an input current or an output current of the series capacitor step-down converter and controls a frequency of the clock signal according to the monitored current.

When a series capacitor step-down converter is operated at a duty cycle of 50%, its step-down ratio will be ¼, but the output voltage will fluctuate according to the output current. Therefore, load regulation can be improved by monitoring the output current or the input current and changing the frequency of the clock signal.

In an embodiment, the frequency controller may include a table defining a relation between the output current and the frequency of the clock signal.

In an embodiment, when a design value of an inductance of two inductors constituting a coupled inductor of the series capacitor step-down converter is L, a design value of a mutual inductance of the two inductors is M, and a design value of a capacitance of a series capacitor is Cr, the frequency of the clock signal may be controlled in a range of a switching frequency higher than a frequency f₀ represented by equation (1).

$$\begin{matrix}[ Math . 1 ] & \\ {f}_{0} = \frac{1}{2 π} \sqrt{\frac{L}{{C}_{r} ( {L}^{2} - {M}^{2} )}} & ( 1 )\end{matrix}$$

In an embodiment, the controller circuit may be monolithically integrated on a single semiconductor substrate. The phrase “monolithically integrated” means a case in which all circuit components are formed on a semiconductor substrate and further means a case in which the main components of a circuit are monolithically integrated, and some resistors, capacitors, or other components may be provided outside the semiconductor substrate. By integrating the circuits on one chip, the circuit area can be reduced, and the characteristics of the circuit elements can be kept uniform.

A series capacitor step-down converter according to an embodiment includes a main circuit of the series capacitor step-down converter and any of the controller circuits described above for driving the switching elements included in the main circuit.

### EMBODIMENTS

Preferred embodiments are described below with reference to the drawings. The same or equivalent constituent elements, members, and processes illustrated in each drawing are denoted by the same reference symbols, and duplication of description will be omitted as appropriate. Moreover, the embodiments are illustrative without limiting the disclosure, and all features or combinations thereof described in the embodiments are not necessarily essential to the disclosure.

In the present specification, “a state in which a member A is connected to a member B” includes a case in which the member A and the member B are indirectly connected to each other through other members that do not substantially affect their electrical connection state nor impair the functions and effects achieved by their combination, in addition to a case in which the member A and the member B are physically and directly connected to each other.

Similarly, “a state in which a member C is connected (provided) between the member A and the member B” includes a case where the member A and the member C, or the member B and the member C are indirectly connected to each other through other members that do not substantially affect their electrical connection state nor impair the functions and effects achieved by their combination, in addition to a case where the member A and the member C, or the member B and the member C are directly connected to each other.

Further, in the present specification, symbols attached to electric signals such as voltage signals and current signals or circuit elements such as resistors, capacitors, and inductors refer to voltage values, current values, or circuit constants (resistance values, capacitance values, inductances) thereof, respectively, as needed.

The vertical and horizontal axes of waveform diagrams and time charts to be referred to in the present specification are enlarged or reduced as appropriate for ease of understanding, and each illustrated waveform is also simplified, exaggerated, or emphasized for ease of understanding.

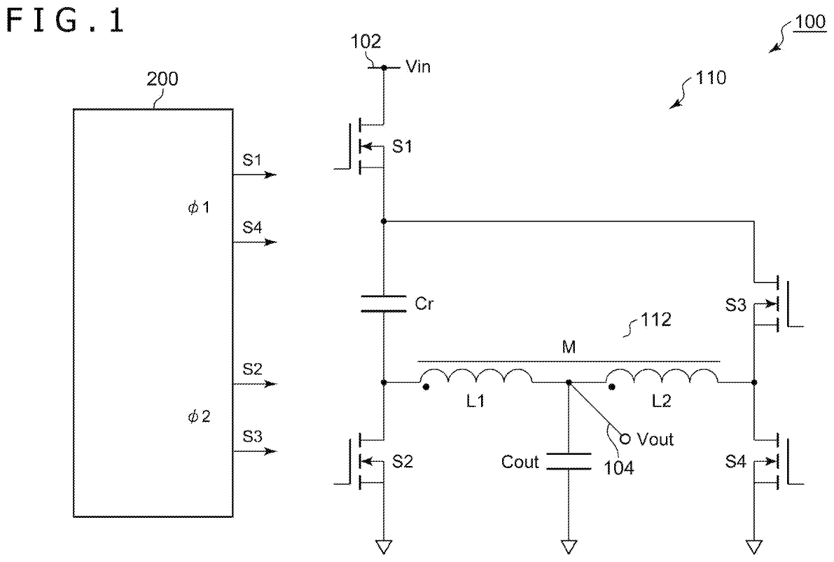

FIG. 1 is a circuit diagram of a series capacitor step-down converter 100 according to an embodiment. The series capacitor step-down converter 100 steps down an input voltage Vin supplied to an input line 102 and generates a stepped-down output voltage Vout on an output line 104.

The series capacitor step-down converter 100 includes a main circuit 110 and a controller IC 200. The controller IC 200 is an application specific integrated circuit (ASIC) integrated on one semiconductor substrate.

The main circuit 110 includes a first switch S1 to a fourth switch S4, a coupled inductor 112, a series capacitor Cr, and an output capacitor Cout.

The first switch S1 has a first end connected to the input line 102. The coupled inductor 112 is a transformer and includes a first inductor L1 and a second inductor L2 that are magnetically coupled to each other. The first inductor L1 and the second inductor L2 have an equal inductance L, and further have a mutual inductance M. A first end of each of the first inductor L1 and the second inductor L2 is connected to the output line 104.

A second switch S2 is connected between a second end of the first inductor L1 and a ground. The series capacitor Cr is connected between a second end of the first switch S1 and the second end of the first inductor L1. A third switch S3 is connected between the second end of the first switch S1 and a second end of the second inductor L2. The fourth switch S4 is connected between the second end of the second inductor L2 and a ground. The output capacitor Cout is connected between the output line 104 and a ground.

In this example, the first switch S1 to the fourth switch S4 are all illustrated as N-channel metal-oxide-semiconductor field-effect transistors (MOSFETs), but are not limited thereto and other transistors may be used. Also, the second switch S2 and the fourth switch S4 on the lower side may be rectifying elements such as diodes.

The controller IC 200 controls the first switch S1 to the fourth switch S4 to generate the output voltage Vout on the output line 104. To be specific, the controller IC 200 alternately repeats a first state φ1 and a second state φ2 at a predetermined switching frequency f_{SW} with a dead time T_{D} interposed therebetween.
First state φ1:
First switch S1=ON
Second switch S2=OFF
Third switch S3=OFF
Fourth switch S4=ON
Second state φ2:
First switch S1=OFF
Second switch S2=ON
Third switch S3=ON
Fourth switch S4=OFF
Dead time T_{D}:
First switch S1=OFF
Second switch S2=OFF
Third switch S3=OFF
Fourth switch S4=OFF

When the length of each of the first state φ1 and the second state φ2 is T_{ON}, the switching frequency f_{SW} is 1/(2×T_{ON}). In other words, operating at the switching frequency f_{SW} means repeating the first state φ1 and the second state φ2 each length of which is T_{ON}=1/(2×f_{SW}).

The above-described configuration is the configuration of the series capacitor step-down converter 100. Next, operation thereof will be described.

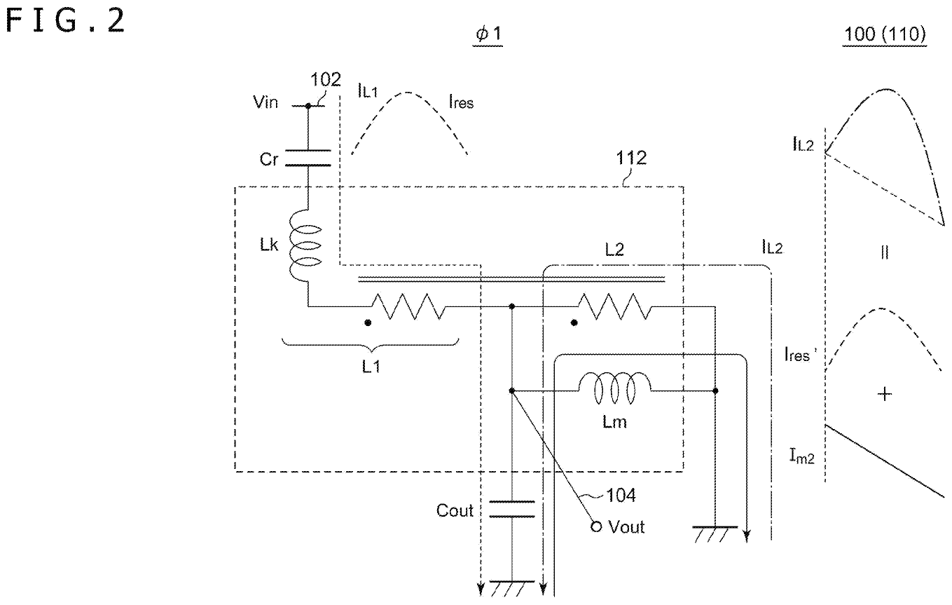

FIG. 2 is an equivalent circuit diagram of the series capacitor step-down converter 100 (main circuit 110) in the first state φ1. The switches S1 and S4 in the on-state are illustrated as simple wires. The coupled inductor 112 is illustrated as an equivalent circuit including an exciting inductance Lm and a leakage inductance Lk. A current flowing through the first inductor L1 is referred to as a first coil current I_{L1}, and a current flowing through the second inductor L2 is referred to as a second coil current I_{L2}.

In the first state φ1, the series capacitor Cr, the first inductor L1 (leakage inductance Lk), and the output capacitor Cout form a series resonance circuit, and a resonance current Iᵣₑₛ flows through the first inductor L1 (I_{L1}=Iᵣₑₛ). The total current of the resonance current Iᵣₑₛ′, which is a replica of the resonance current Iᵣₑₛ flowing through the first inductor L1, and an exciting current Iₘ₂ flowing through the exciting inductance Lm flows through the second inductor L2, and therefore, the second coil current I_{L2} satisfies I_{L2}=Iᵣₑₛ′+Iₘ₂.

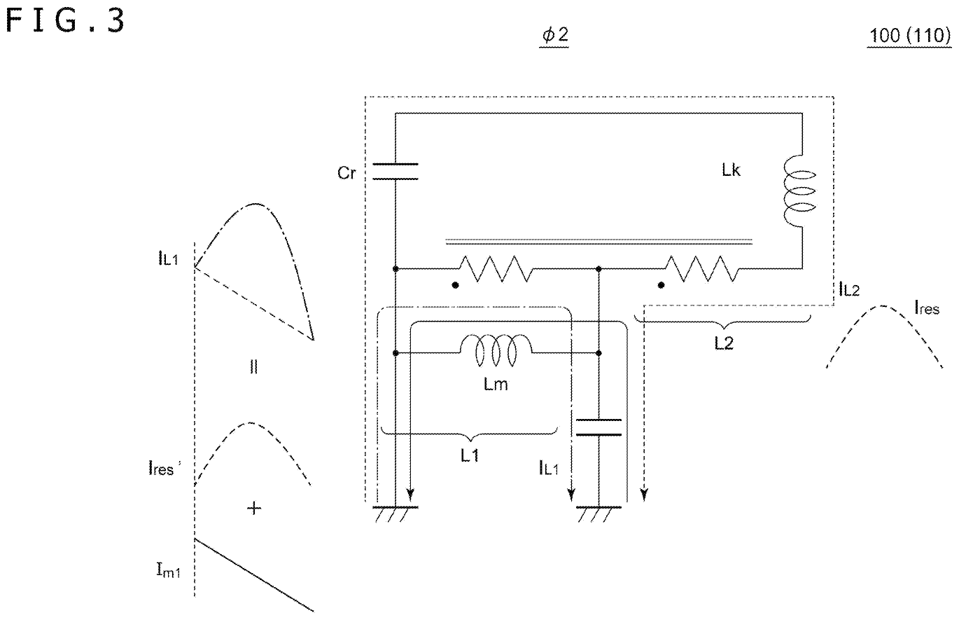

FIG. 3 is an equivalent circuit diagram of the series capacitor step-down converter 100 (main circuit 110) in the second state φ2. The switches S2 and S3 in the on-state are illustrated as simple wires.

In the second state φ2, the series capacitor Cr, the leakage inductance Lk, and the output capacitor Cout form a series resonance circuit, and the resonance current Iᵣₑₛ flows through the second inductor L2 (I L2=Iᵣₑₛ). The total current of a resonance current Iᵣₑₛ′, which is a replica of the resonance current Iᵣₑₛ flowing through the second inductor L2, and an exciting current Iₘ₁ flowing through the exciting inductance Lm flows through the first inductor L1, and therefore, the first coil current I_{L1} satisfies IL₁=Iᵣₑₛ′+Iₘ₁.

When the first state φ1 and the second state φ2 are alternately repeated, a voltage across the series capacitor Cr becomes Vin/2 in the steady state, and the remaining Vin/2 is applied to the coupled inductor 112. When the inductances of the first inductor L1 and the second inductor L2 are equal to each other, the output voltage Vout that is ¼ times Vin is generated on the output line 104.

The conditions for the series capacitor step-down converter 100 to perform zero voltage switching (ZVS) are as follows.
Transition from the first state φ1 to the second state φ2

During the dead time T_{D} immediately after the first state φ1, when I_{L1}≥0 is satisfied, the current I_{L1} flows through a body diode of the second switch S2, and a voltage across the second switch S2 is reduced. At this time, when the state transitions to the second state φ2, that is, when the second switch S2 is turned on, the ZVS of the second switch S2 is established. It should be noted that the direction toward the output line 104 is regarded as the positive direction for the currents I_{L1} and I_{L2}.

Further, during the dead time T_{D}, when I_{L2}<0 is satisfied, a voltage at a connection node between the third switch S3 and the fourth switch S4 increases due to a regenerative current, and a voltage across the third switch S3 decreases. At this time, when the state transitions to the second state φ2, that is, when the third switch S3 is turned on, the ZVS of the third switch S3 is established.
Transition from the second state φ2 to the first state φ1

During the dead time T_{D} immediately after the second state φ2, when I_{L1}<0 is satisfied, a voltage at a connection node between the first switch S1 and the third switch S3 increases due to the regenerative current, and a voltage across the first switch S1 decreases. At this time, when the state transitions to the first state φ1, that is, when the first switch S1 is turned on, the ZVS of the first switch S1 is established.

Further, during the dead time T_{D}, when I_{L2}≥0 is satisfied, the current I_{L2} flows through a body diode of the fourth switch S4, and a voltage across the fourth switch S4 is small. At this time, when the state is transitions to the first state φ1, that is, when the fourth switch S4 is turned on, the ZVS of the fourth switch S4 is established.

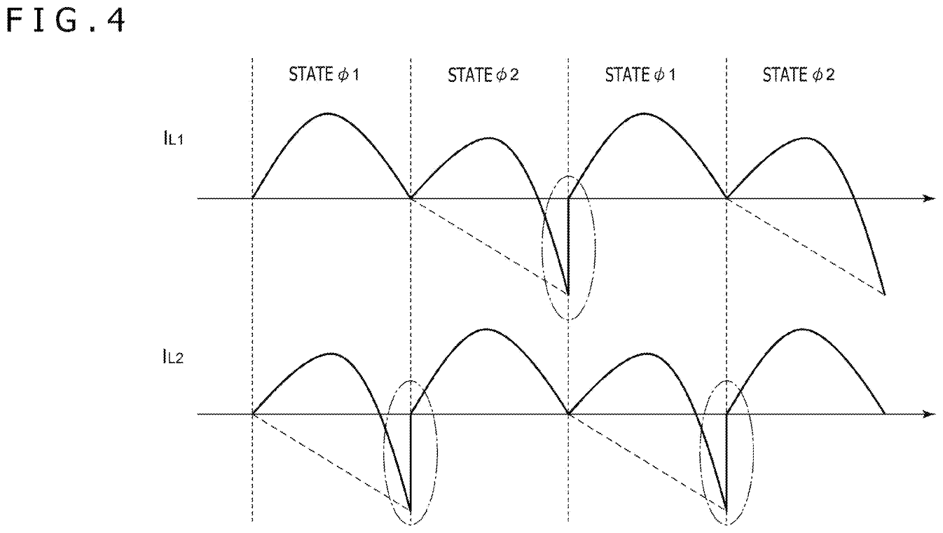

FIG. 4 is a current waveform diagram of the series capacitor step-down converter 100. A switching frequency f_{SW} agrees with a resonance frequency f₀ of the main circuit 110, and the first state φ1 and the second state φ2 transition at the timing when the resonance current Iᵣₑₛ becomes zero. The dead time is omitted here. FIG. 4 illustrates current waveforms obtained when the first switch S1 to the fourth switch S4 are assumed to be ideal switches, that is, when the first switch S1 to the fourth switch S4 do not include a parasitic capacitance.

At the timing of the end of the first state φ1, the current I_{L1} of the first inductor L1 is positive or zero (I_{L1}≥0), and the current I_{L2} of the second inductor L2 is negative (I_{L2}<0), so that the conditions of the ZVS mentioned above are satisfied.

Similarly, at the timing of the end of the second state φ2, the current I_{L1} through the first inductor L1 is negative (I_{L1}<0) and the current I_{L2} through the second inductor L2 is positive or zero (I_{L2}≥0), so that the ZVS conditions mentioned above are satisfied.

Thus, the series capacitor step-down converter 100 can satisfy the ZVS conditions by switching at the resonance frequency f₀, and can operate with high efficiency.

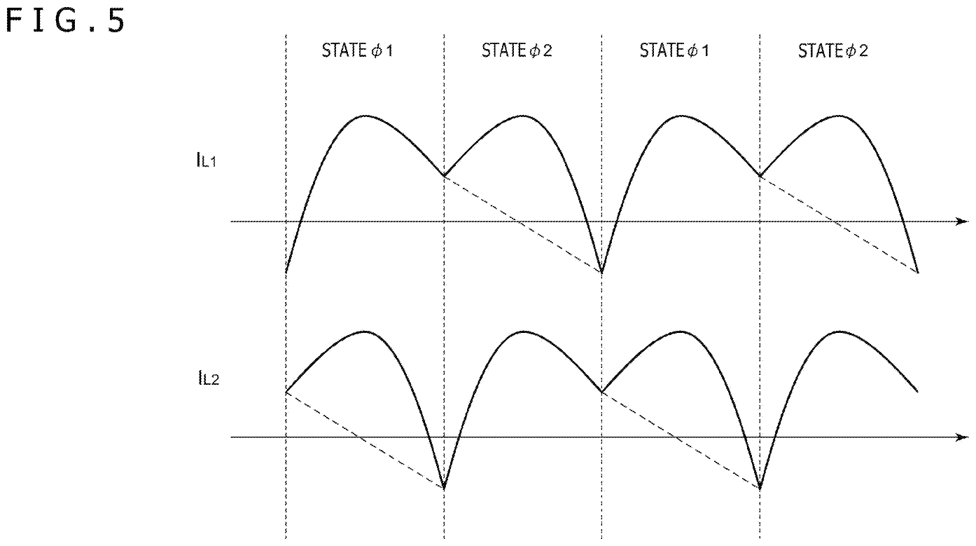

FIG. 5 is a current waveform diagram of the series capacitor step-down converter 100. Although FIG. 4 illustrates waveforms ignoring the parasitic capacitance of the MOSFET, in practice, the parasitic capacitance exists. This parasitic capacitance suppresses current discontinuity across the dead time. The coil currents I_{L1} and I_{L2} are continuous, and have waveforms symmetrical on the time axis with respect to the dead time in the first state φ1 and the second state φ2.

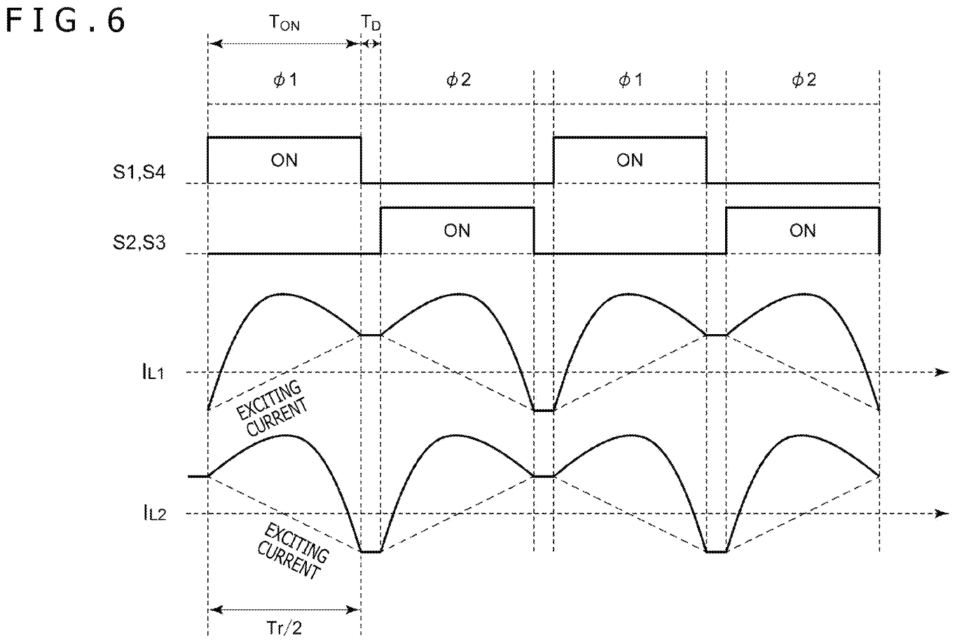

FIG. 6 is a time chart illustrating the operation of the series capacitor step-down converter 100 in consideration of the dead time T_{D}. FIG. 6 illustrates the operation performed when the switching frequency f_{SW} is equal to the resonance frequency f₀, and a length T_{ON} of each of the first state φ1 and the second state φ2 is half a resonance period Tᵣ(=1/fᵣ).

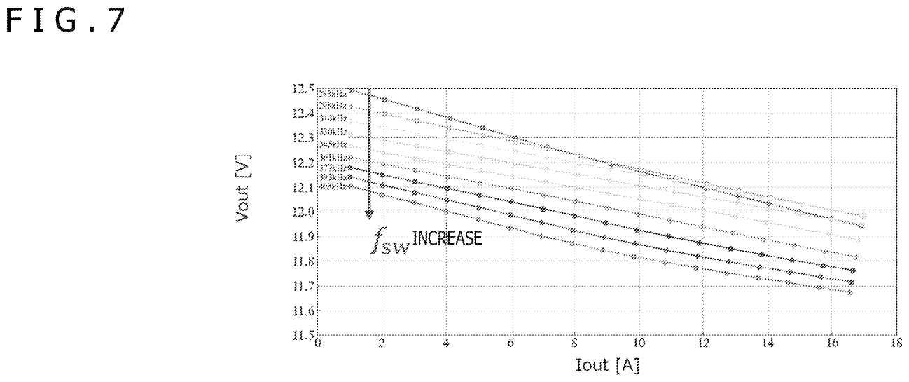

FIG. 7 is a diagram illustrating a relation between the output current Iout and the output voltage Vout of the series capacitor step-down converter 100. The input voltage Vin is 48 V, and the output voltage Vout is 12 V when the step-down ratio is ¼. FIG. 7 illustrates characteristics at the time of being operated at a plurality of different switching frequencies. Here, the resonance frequency f₀ is 314 kHz.

At the same frequency, the output voltage Vout decreases as the output current Iout increases. For the same output current Tout, the output voltage Vout tends to be lower as the switching frequency becomes higher. The controller IC 200 capable of stabilizing the output voltage Vout will be described below.

### Example 1

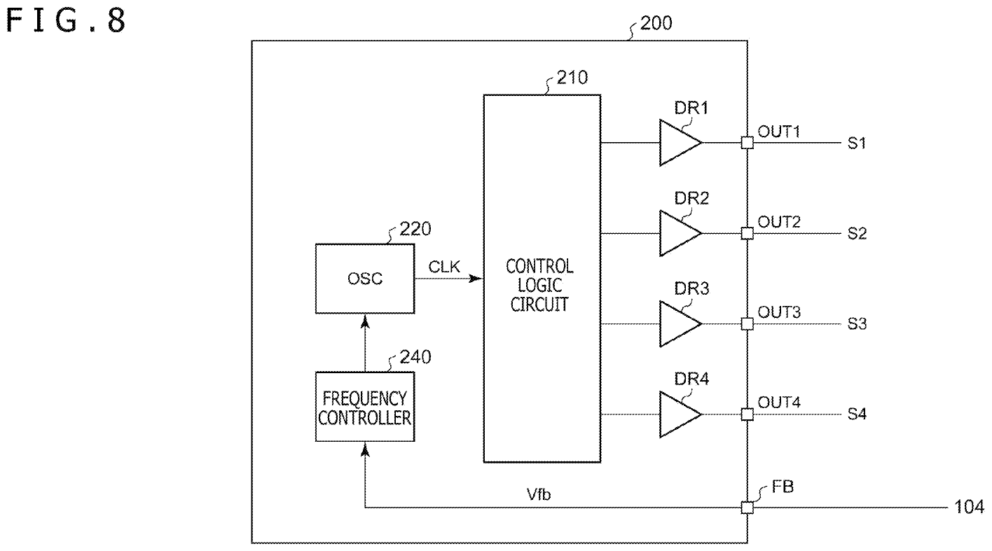

FIG. 8 is a block diagram of the controller IC 200 according to Example 1. The controller IC 200 is provided with a control logic circuit 210, an oscillator 220, and a frequency controller 240. The controller IC 200 is provided with a first output pin OUT1 to a fourth output pin OUT4 and a feedback pin FB. The first to fourth output pins OUT1 to OUT4 are connected to gates of the first to fourth switches S1 to S4, respectively. A feedback voltage Vfb indicating the output voltage Vout of the series capacitor step-down converter 100 is input to the feedback pin FB.

The oscillator 220 generates a clock signal CLK that specifies the switching frequency. The oscillator 220 has a variable oscillation frequency. The control logic circuit 210 alternately repeats the first state φ1 and the second state φ2 in synchronization with the clock signal CLK with a dead time interposed. Drivers DR1 to DR4 drive the corresponding switches S1 to S4 according to control signals generated by the control logic circuit 210.

The feedback voltage Vfb is input to the frequency controller 240. The frequency controller 240 controls the oscillation frequency of the oscillator 220, that is, the frequency of the clock signal CLK, on the basis of the feedback voltage Vfb.

To be specific, the frequency controller 240 decrease the frequency of the clock signal CLK when the output voltage Vout is lower than a predetermined threshold voltage Vth, in other words, when the feedback voltage Vfb is lower than a reference voltage Vref corresponding to the threshold voltage Vth. Further, the frequency controller 240 increases the frequency of the clock signal CLK when the output voltage Vout is higher than the threshold voltage Vth, in other words, when the feedback voltage Vfb is higher than the reference voltage Vref.

The configurations of the frequency controller 240 and the oscillator 220 are not particularly limited to any kind, and known techniques may be used.

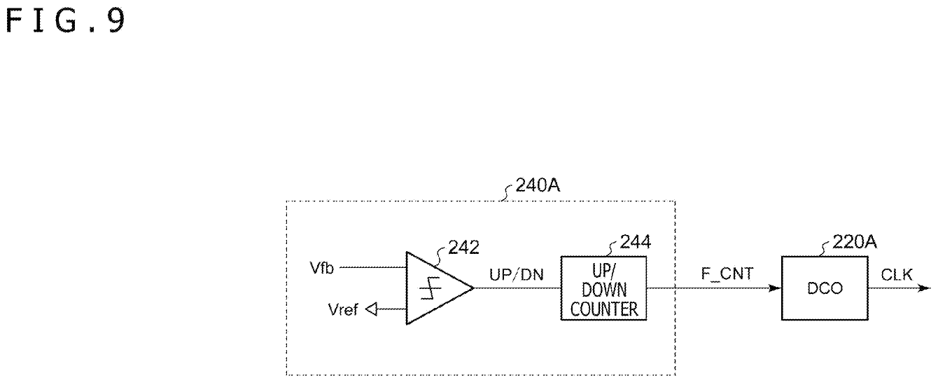

FIG. 9 is a block diagram illustrating a configuration example of a frequency controller 240A and an oscillator 220A. The oscillator 220A is a digital controlled oscillator (DCO) whose frequency can be controlled according to a digital code F_CNT. The configuration of the DCO is not particularly limited to any kind, and may be a ring oscillator in which a bias current of an inverter, which is a delay element, is made variable according to the digital code, for example. Alternatively, the DCO may be an oscillator that repeats charging and discharging of a capacitor, or may be configured such that a charging current of the capacitor is variable according to a digital code.

The frequency controller 240A includes a comparator 242 and an up/down counter 244. The comparator 242 compares the feedback voltage Vfb with a predetermined reference voltage Vref and generates an up/down signal UP/DN according to the comparison result. The up/down counter 244 counts up or down according to the up/down signal UP/DN. A count value of the up/down counter 244 is supplied to the oscillator 220A as the digital code F_CNT.

The comparator 242 may be a hysteresis comparator. Alternatively, the comparator 242 may be a window comparator. In another control example, the frequency controller 240A decreases the frequency of the clock signal CLK when the output voltage Vout is lower than a lower limit Vmin of a predetermined target voltage range, in other words, when the feedback voltage Vfb is lower than a reference voltage Vthl corresponding to the lower limit Vmin. Further, the frequency controller 240A increases the frequency of the clock signal CLK when the output voltage Vout is higher than an upper limit Vmax of the predetermined target voltage range, in other words, when the feedback voltage Vfb is higher than a reference voltage Vthh corresponding to the upper limit Vmax.

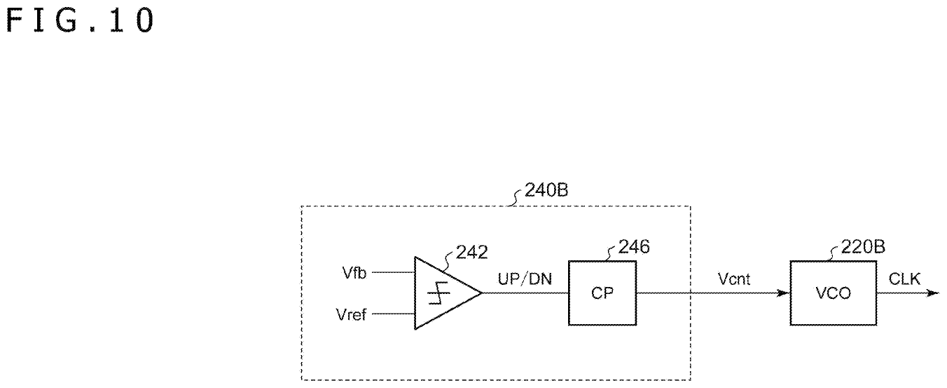

FIG. 10 is a block diagram illustrating a configuration example of a frequency controller 240B and an oscillator 220B. The oscillator 220B is a voltage controlled oscillator (VCO) whose frequency can be controlled according to an analog control voltage Vcnt. The configuration of the VCO is not particularly limited to any kind, and may be a ring oscillator or an oscillator that repeats charging and discharging of a capacitor.

The frequency controller 240B includes the comparator 242 and a charge pump circuit 246. The comparator 242 compares a feedback voltage Vfb with a predetermined reference voltage Vref and generates the up/down signal UP/DN according to the comparison result. The charge pump circuit 246 generates the analog control voltage Vcnt whose voltage level rises or falls according to the up/down signal UP/DN.

The configuration of the controller IC 200 is described above. According to the controller IC 200 in Example 1, the oscillation frequency of the oscillator 220, that is, the switching frequency of the series capacitor step-down converter 100, changes such that the feedback voltage Vfb approaches the reference voltage Vref. As a result, the output voltage Vout can be stabilized regardless of fluctuation of the output current Iout, and load regulation can be improved.

### Example 2

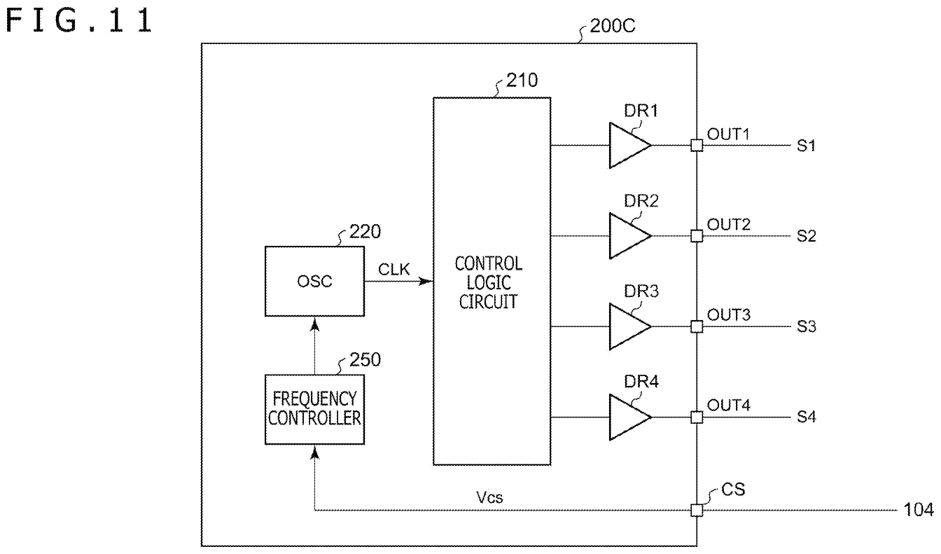

FIG. 11 is a block diagram of a controller IC 200C according to Example 2. The controller IC 200C includes the control logic circuit 210, the oscillator 220, and a frequency controller 250. A current detection signal Vcs indicating the output current Iout of the series capacitor step-down converter 100 is input to a current detection pin CS of the controller IC 200C. A method for detecting the output current Iout is not particularly limited to any kind, and a known technique may be used.

The frequency controller 250 receives the current detection signal Vcs indicating the output current Iout of the series capacitor step-down converter 100. The frequency controller 250 controls the oscillation frequency of the controller IC 200C according to the current detection signal Vcs.

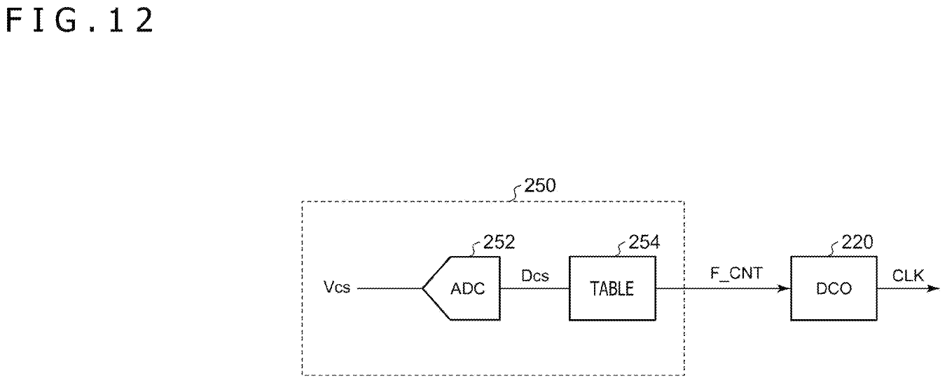

FIG. 12 is a block diagram illustrating a configuration example of the frequency controller 250. The oscillator 220 is a digitally controllable DCO. The frequency controller 250 includes an analog-to-digital (A/D) converter 252 and a table 254. The A/D converter 252 converts the current detection signal Vcs into a digital signal Dcs.

The table 254 is a lookup table that defines a relation between the current detection signal Vcs and the oscillation frequency, in other words, a relation between the digital signal Dcs and the digital code F_CNT. The oscillator 220 oscillates at a frequency corresponding to the digital code F_CNT.

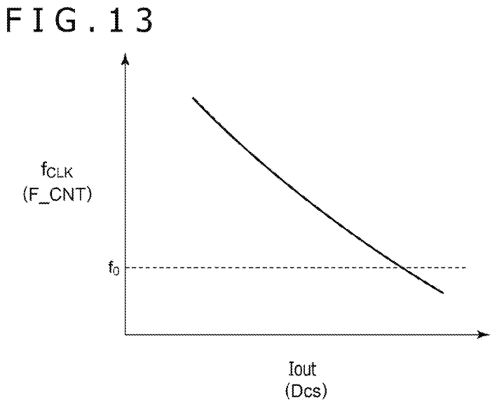

FIG. 13 is a diagram illustrating a relation between the output current Iout and a frequency f_{CLK} of the clock signal CLK. As illustrated in FIG. 7, as the output current Iout increases, the switching frequency for setting the output voltage Vout to a target voltage (for example, 12 V) decreases. The relation in FIG. 13 can be determined on the basis of the output current/output voltage characteristics.

According to Example 2, by selecting an appropriate switching frequency according to the output current Tout, the output voltage Vout at the target level can be maintained, which improves load regulation.

Next, the variable range of the switching frequency will be described.

The inventors have found that the following problems arise when a situation in which the switching frequency is lower than the resonance frequency, in other words, a situation in which an on-time T_{ON} of the first state φ1 and the second state φ2 is longer than half the resonance time (resonance half-cycle), that is, Tr/2, occurs.

With reference to FIG. 6, if T_{ON} is too long compared to the resonance half-cycle Tr/2, the current II becomes a negative current at the timing of transition from the first state φ1 to the second state φ2, and thus, the ZVS conditions are not satisfied.

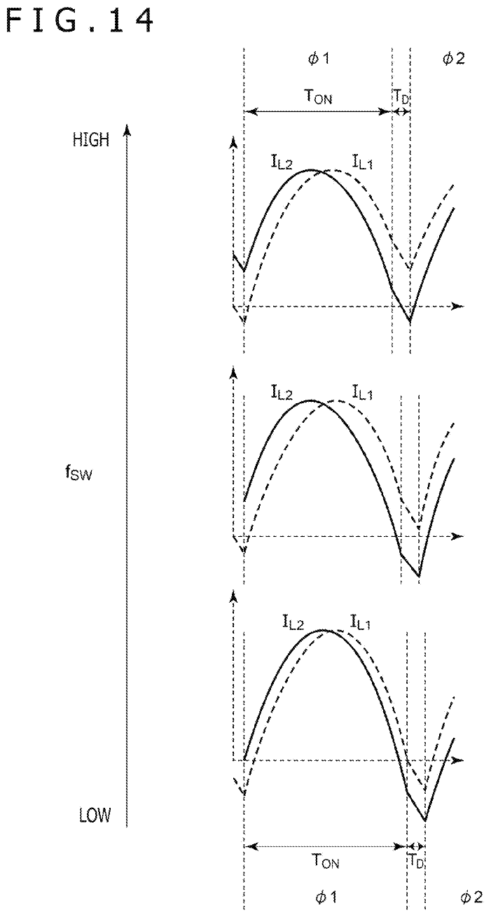

FIG. 14 is a diagram for illustrating current waveforms when the switching frequency f_{SW} is changed. When the switching frequency f_{SW} is low (the bottom in FIG. 14), in other words, when the on-time T_{ON} is long, the current I_{L1} of the first inductor L1 becomes a negative current at the timing of transition to the dead time T_{D}. Since the current I_{L1} further decreases during the dead time T_{D}, I_{L1}≥0 does not hold regardless of whether the dead time T_{D} is lengthened or shortened, and the ZVS conditions cannot be satisfied, resulting in poor efficiency.

On the other hand, when the switching frequency f_{SW} is high (the top in FIG. 14), in other words, when the on-time T_{ON} becomes short, the current I_{L1} of the first inductor L1 and the current I_{L2} of the second inductor L2 both become positive at the timing of transition to the dead time T_{D}. In this case, by lengthening the dead time T_{D}, a state of I_{L1}>0 and I_{L2}<0 can be created, and the ZVS conditions can be satisfied.

Therefore, when dynamic control of the switching frequency described in Example 1 or Example 2 is introduced, a low switching frequency f_{SW} is selected in a heavy load state where the output current Tout is large. If there is no restriction on the switching frequency f_{SW}, the ZVS conditions will not be satisfied, resulting in a drop in efficiency.

Therefore, it is preferable to make the oscillation frequency of the oscillator 220 variable in a range higher than the resonance frequency. The length of the dead time T_{D} should be determined such that the ZVS conditions are satisfied when the resonance frequency fᵣ takes the lowest value in the assumed range.

To be specific, the frequency of the clock signal CLK, that is, the switching frequency f_{SW}, is set higher than the frequency f₀ determined by equation (1).

$$\begin{matrix}[ Math . 2 ] & \\ {f}_{0} = \frac{1}{2 π} \sqrt{\frac{L}{{C}_{r} ( {L}^{2} - {M}^{2} )}} & ( 1 )\end{matrix}$$

L is a design value of the inductance of the first inductor L1 and the second inductor L2, M is a design value of the mutual inductance of the first inductor L1 and the second inductor L2, and Cr is a design value of the capacitance of the series capacitor.

For example, the switching frequency f_{SW} can be variable with a lower limit of 1.05 times the frequency f₀. More preferably, the switching frequency f_{SW} can be variable with a lower limit of 1.1 times the frequency f₀. By setting the lower limit higher than f₀ defined by equation (1), the ZVS conditions can be satisfied with a realistic length of the dead time T_{D} even when the actual resonance frequency varies.

### (Application)

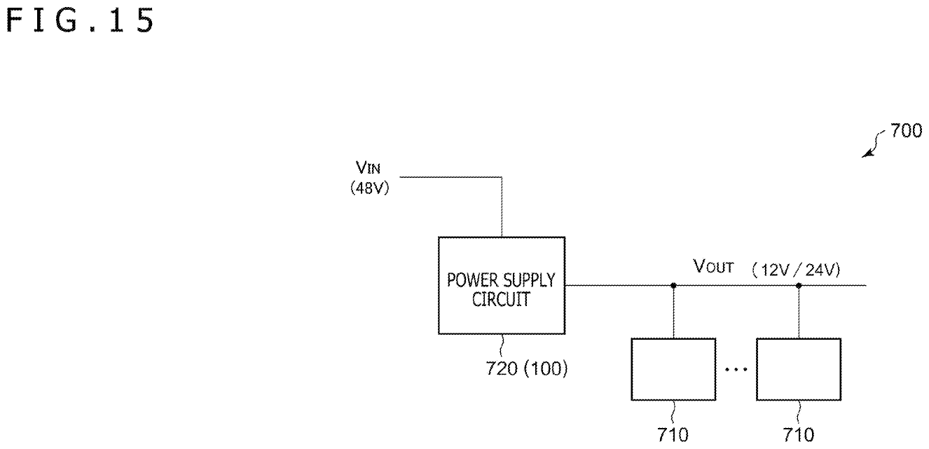

FIG. 15 is a diagram illustrating an example of an electronic device 700 including the series capacitor step-down converter 100. A suitable example of the electronic device 700 is a server. Since a 12 V power supply line is originally drawn into the server, an internal circuit 710 is designed to operate at 12 V. The internal circuit 710 can include a central processing unit (CPU), a memory, a local area network (LAN) interface circuit, and a DC/DC converter that steps down a voltage of 12 V, for example.

In recent years, there has been a movement to replace a bus voltage from 12 V to 48 V in order to reduce a current flowing through the wires. In this case, a power supply circuit 720 for stepping down the power supply voltage of 48 V to 12 V is required. The above-described series capacitor step-down converter 100 with a ¼ gain can be suitably used for such a power supply circuit 720.

The electronic device 700 is not limited to a server, and may be an in-vehicle device. Automobile batteries in related art are mainly of 12 V or 24 V, but for hybrid vehicles, there are cases where a 48 V system is adopted, and in this case also, a power supply circuit that converts the battery voltage from 48 V to 12 V is required. In such a case, the series capacitor step-down converter 100 with a ¼ gain can be suitably used.

In addition, the electronic device 700 may be industrial equipment, office automation (OA) equipment, or consumer equipment such as audio equipment.

### (Additional Statement)

The technology included in the present disclosure can be understood as follows.

### (Item 1)

A controller circuit for a series capacitor step-down converter, the circuit including:
an oscillator that generates a clock signal;
a control logic circuit that generates a plurality of control signals for controlling a plurality of switching elements of the series capacitor step-down converter in synchronization with the clock signal;
a plurality of drivers that drive the plurality of switching elements according to the plurality of control signals; and
a frequency controller that controls a frequency of the clock signal on the basis of an output voltage of the series capacitor step-down converter.

### (Item 2)

The controller circuit according to Item 1, in which
the frequency controller reduces the frequency of the clock signal when the output voltage is lower than a predetermined threshold voltage, and increases the frequency of the clock signal when the output voltage is higher than the threshold voltage.

### (Item 3)

The controller circuit according to Item 1, in which
the frequency controller reduces the frequency of the clock signal when the output voltage is lower than a lower limit of a predetermined voltage range, and increases the frequency of the clock signal when the output voltage is higher than an upper limit of the predetermined voltage range.

### (Item 4)

A controller circuit for a series capacitor step-down converter, the circuit including:
an oscillator that generates a clock signal;
a control logic circuit that generates a plurality of control signals for controlling a plurality of switching elements of the series capacitor step-down converter in synchronization with the clock signal;
a plurality of drivers that drive the plurality of switching elements according to the plurality of control signals; and
a frequency controller that monitors an input current or an output current of the series capacitor step-down converter and controls a frequency of the clock signal according to the monitored current.

### (Item 5)

The controller circuit according to Item 4, in which
the frequency controller includes a table defining a relation between the output current and the frequency of the clock signal.

### (Item 6)

The controller circuit according to any one of Items 1 to 5, in which,
when a design value of an inductance of two inductors constituting a coupled inductor of the series capacitor step-down converter is L, a design value of a mutual inductance of the two inductors is M, and a design value of a capacitance of a series capacitor is Cr, the frequency of the clock signal is controlled in a range of a switching frequency higher than a frequency f₀ represented by equation (1).

$$\begin{matrix}[ Math . 3 ] & \\ {f}_{0} = \frac{1}{2 π} \sqrt{\frac{L}{{C}_{r} ( {L}^{2} - {M}^{2} )}} & ( 1 )\end{matrix}$$

### (Item 7)

The controller circuit according to any one of Items 1 to 6, in which
the controller circuit is monolithically integrated on one semiconductor substrate.

### (Item 8)

A series capacitor step-down converter including:
a main circuit of the series capacitor step-down converter; and
the controller circuit according to any one of Items 1 to 7, the controller circuit driving the switching elements included in the main circuit.

### (Item 9)

A method for controlling a series capacitor step-down converter, the method including:
generating a clock signal with an oscillator;
driving a plurality of switching elements of the series capacitor step-down converter in synchronization with the clock signal; and
controlling a frequency of the clock signal on the basis of an output voltage of the series capacitor step-down converter.

### (Item 10)

A method for controlling a series capacitor step-down converter, the method including:
generating a clock signal with an oscillator;
driving a plurality of switching elements of the series capacitor step-down converter in synchronization with the clock signal; and
monitoring an input current or an output current of the series capacitor step-down converter and controlling a frequency of the clock signal according to the monitored current.

The embodiments are examples, and it is understood by those skilled in the art that there are various modifications in the combination of components and processing processes and that such modifications are also included in the present disclosure and can constitute the scope of the present disclosure.

According to an embodiment of the present disclosure, fluctuation of an output voltage can be suppressed.

What is claimed is:

1. A controller circuit for a series capacitor step-down converter, the circuit comprising:
an oscillator that generates a clock signal;
a control logic circuit that generates a plurality of control signals for controlling a plurality of switching elements of the series capacitor step-down converter in synchronization with the clock signal;
a plurality of drivers that drive the plurality of switching elements according to the plurality of control signals; and
a frequency controller that controls a frequency of the clock signal on a basis of an output voltage of the series capacitor step-down converter.

2. The controller circuit according to claim 1, wherein
the frequency controller reduces the frequency of the clock signal when the output voltage is lower than a predetermined threshold voltage, and increases the frequency of the clock signal when the output voltage is higher than the threshold voltage.

3. The controller circuit according to claim 1, wherein
the frequency controller reduces the frequency of the clock signal when the output voltage is lower than a lower limit of a predetermined voltage range, and increases the frequency of the clock signal when the output voltage is higher than an upper limit of the predetermined voltage range.

4. A controller circuit for a series capacitor step-down converter, the circuit comprising:
an oscillator that generates a clock signal;
a control logic circuit that generates a plurality of control signals for controlling a plurality of switching elements of the series capacitor step-down converter in synchronization with the clock signal;
a plurality of drivers that drive the plurality of switching elements according to the plurality of control signals; and
a frequency controller that monitors an input current or an output current of the series capacitor step-down converter and controls a frequency of the clock signal according to the monitored current.

5. The controller circuit according to claim 4, wherein
the frequency controller includes a table defining a relation between the output current and the frequency of the clock signal.

6. The controller circuit according to claim 1, wherein,
when a design value of an inductance of two inductors constituting a coupled inductor of the series capacitor step-down converter is L, a design value of a mutual inductance of the two inductors is M, and a design value of a capacitance of a series capacitor is Cr, the frequency of the clock signal is controlled in a range of a switching frequency higher than a frequency f₀ represented by equation (1).
$$\begin{matrix}[ Math . 1 ] & \\ {f}_{0} = \frac{1}{2 π} \sqrt{\frac{L}{{C}_{r} ( {L}^{2} - {M}^{2} )}} & ( 1 )\end{matrix}$$

7. The controller circuit according to claim 4, wherein,
when a design value of an inductance of two inductors constituting a coupled inductor of the series capacitor step-down converter is L, a design value of a mutual inductance of the two inductors is M, and a design value of a capacitance of a series capacitor is Cr, the frequency of the clock signal is controlled in a range of a switching frequency higher than a frequency f₀ represented by equation (1).
$$\begin{matrix}[ Math . 1 ] & \\ {f}_{0} = \frac{1}{2 π} \sqrt{\frac{L}{{C}_{r} ( {L}^{2} - {M}^{2} )}} & ( 1 )\end{matrix}$$

8. The controller circuit according to claim 1, wherein
the controller circuit is monolithically integrated on one semiconductor substrate.

9. The controller circuit according to claim 4, wherein
the controller circuit is monolithically integrated on one semiconductor substrate.

10. A series capacitor step-down converter comprising:
a main circuit of the series capacitor step-down converter; and
the controller circuit according to claim 1, the controller circuit driving the switching elements included in the main circuit.

11. A series capacitor step-down converter comprising:
a main circuit of the series capacitor step-down converter; and
the controller circuit according to claim 4, the controller circuit driving the switching elements included in the main circuit.

12. A method for controlling a series capacitor step-down converter, the method comprising:
generating a clock signal with an oscillator;
driving a plurality of switching elements of the series capacitor step-down converter in synchronization with the clock signal; and
controlling a frequency of the clock signal on a basis of an output voltage of the series capacitor step-down converter.

13. A method for controlling a series capacitor step-down converter, the method comprising:
generating a clock signal with an oscillator;
driving a plurality of switching elements of the series capacitor step-down converter in synchronization with the clock signal; and
monitoring an input current or an output current of the series capacitor step-down converter and controlling a frequency of the clock signal according to the monitored current.
